(19) United States
(12) Patent Application Publication
(10) Pub. No.: US 2020/0029544 A1
(43) Pub. Date: Jan. 30, 2020

(54) Fishing Rod Holder and Method of Using the Same

(71) Applicant: Johnathon Bryan Draper, Cashmere, WA (US)

(72) Inventor: Johnathon Bryan Draper, Cashmere, WA (US)

(21) Appl. No.: 16/491,303

(22) PCT Filed: Mar. 5, 2018
(86) PCT No.: PCT/US18/20855

§ 371 Date: Sep. 5, 2019

Related U.S. Application Data
(60) Provisional application No. 62/467,235, filed on Mar. 5, 2017.

(51) Int. Cl. A01K 97/10; F16M 13/02; B63B 17/00

(52) U.S. Cl. CPC A01K 97/10; F16M 13/022; B63B 2017/0054; F16M 2200/06; B63B 17/00

(57) ABSTRACT

An apparatus for retaining an unattended fishing rod. The apparatus is comprised of a fishing rod holder and an extendable fishing rod holder base. The fishing rod holder releasably retains a handle of a fishing rod, such that the fishing rod is held fast against lateral force in a lateral direction or longitudinal force in a longitudinal direction. A releasable spindle of the fishing rod holder releasably operably couples to a socket of the fishing rod holder base, easily detaching from the fishing rod base in a single, instantaneous, smooth motion, allowing the user to pick up or replace the fishing rod with ease. Vertical force from the user will release the coupling of the fishing rod holder and the fishing rod holder base, but I lateral force in a lateral direction or longitudinal force in a longitudinal direction will not.

### I. FIELD OF THE INVENTION

The present invention relates generally to devices used to store, releasably hold, releasably retain or releasably restrict the undesired movement of a fishing rod, in a location where it can be easily withdrawn for immediate use.

### II. BACKGROUND

Fishing rod holders are used in the fishing industry in general to be mounted to a gunnel or outrigger of water vessels or stationary platforms such as docks or the like. A fishing rod holder may function to hold a fishing rod in a substantially secure orientation before, during, or after a strike by a game fish during fishing in a well-known and conventional manner. In addition, the fishing rod should be reasonably accessible, such that the fisherman may grab the rod if the bait of the fishing pole is taken by a fish and remove it from its stored location to a reeling in position of the fishing pole where the fisherman is actively and dynamically reeling in his catch.

Prior art fishing rod holders generally rely on releasable clamping mechanisms for positioning a fishing rod in its stored position that is substantially secure from removal upon the load exerted thereon by a fish at the forward end portion of a pole and having easy and convenient access to the fishing rod for removing it from the stored location by the fisherman on quick demand when a bite is on the line of the fishing rod line.

FIGS. 11-14 (PRIOR ART, FIGS. 2, 5, 7, and 6) depict cross-sectional or side elevation views of a fishing rod holder assembly (PRIOR ART REF. 20) with one moving piece with an axes system (PRIOR ART REF. 10) that includes an offset rotation axis (PRIOR ART REF. 16), disclosed in U.S. Pat. No. 7,406,795 B1 to Follmar (hereinafter “PRIOR ART”). The axes system (PRIOR ART REF. 10) correlates to the fishing rod retention assembly (PRIOR ART REF. 20). A longitudinal axis (PRIOR ART REF. 12) is generally defined by the center axis of the rod retention conduit (PRIOR ART REF. 152) depicted in FIGS. 12-14 (PRIOR ART, FIGS. 5, 3, 4) and described below. A lateral axis (PRIOR ART REF. 14) is defined as a lateral direction. A substantially vertical axis (PRIOR ART REF. 16) is orthogonal to the longitudinal axis (PRIOR ART REF. 12) and the lateral axis (PRIOR ART REF. 14). It should be noted that in practice the substantially vertical axis (PRIOR ART REF. 16) is not perfectly vertical and aligned with the flux field of gravity, but rather, at an angle tilted rearwardly (offset) toward the boat or stationary platform (such as a fishing platform) (PRIOR ART REF. 160) as shown in FIG. 11 (PRIOR ART, FIG. 2). It should be noted that the axes system (PRIOR ART REF. 10) is relative to the upper portion of the fishing rod retention assembly (PRIOR ART REF. 20) and hence moves therewith.

FIG. 11 (PRIOR ART, FIG. 2) depicts a side elevation view of the fishing rod retention assembly (PRIOR ART REF. 20) is attached to a boat or stationary platform (PRIOR ART REF. 160). The boat or stationary platform (PRIOR ART REF. 160) is defined broadly as amounting location which in one form is a moving frame of reference such as a boat where the fishing rod (PRIOR ART REF. 162) is desired to be positioned in an active fishing orientation without the fisherman having to hold onto the fishing rod constantly. Alternatively, the fishing rod retention assembly (PRIOR ART REF. 20) can be mounted to a stationary platform such as a pier, whereby the fisherman does not need to hold the fishing rod (PRIOR ART REF. 162), but rather, desires a rod retention assembly (PRIOR ART REF. 20) to provide quick access to the fishing rod (PRIOR ART REF. 162) when a fish takes the bait off of the fishing rod's line. The fishing rod (PRIOR ART REF. 162) includes having a reel seat area (PRIOR ART REF. 164) that is generally defined as a portion of the fishing rod grasping area in the area adapted to mount the reel (PRIOR ART REF. 166) thereto. The reel (PRIOR ART REF. 166) is adapted to be interposed between the members (PRIOR ART REF. 35) and (PRIOR ART REF. 37) of the upper retention extension (PRIOR ART REF. 32) as seen in FIG. 11 (PRIOR ART, FIG. 2).

FIG. 12 (PRIOR ART, FIG. 5) shows a method of inserting the rod (PRIOR ART REF. 162) into the fishing rod retention assembly (PRIOR ART REF. 20), whereby the fishing rod retention assembly (PRIOR ART REF. 20) is in an open position and the rod retention conduit (PRIOR ART REF. 152) is in an open exposed orientation, and the reel seat area (PRIOR ART REF. 164) is adapted to engage a rotating retention surface (PRIOR ART REF. 36) of the upper and lower retention members (PRIOR ART REF. 32) and (PRIOR ART REF. 34), depicted FIG. 11 (PRIOR ART, FIG. 2) and described above. The rotating retention surface (PRIOR ART REF. 36) is adapted to engage the outer cylindrical surface of the reel seat area (PRIOR ART REF. 164) (see FIG. 11 (PRIOR ART, FIG. 2) whereby the cross-sectional diameter of the partially cylindrical-like portions of the rotating retention surface (PRIOR ART REF. 36) is slightly greater than the diameter of the conical or partially frustoconical surface of the handle region of the fishing rod (PRIOR ART REF. 162). A retainer (PRIOR ART REF. 180) as shown in FIG. 12 (PRIOR ART, FIG. 5) comprising a grasping region (PRIOR ART REF. 182) and a central shaft region (PRIOR ART REF. 184). The grasping region (PRIOR ART REF. 182) has a laterally inward surface (PRIOR ART REF. 186) that is adapted to engage the fingers of a fisherman when manipulating the retainer (PRIOR ART REF. 180) laterally inwardly and outwardly. When a fisherman desires to orientate the fishing rod retention assembly (PRIOR ART REF. 20) in a manner so that the fishing rod is only partially securely locked within the rod retention conduit (PRIOR ART REF. 152), the fisherman engages the laterally inward surface (PRIOR ART REF. 186) and repositions the retainer (PRIOR ART REF. 180) in a direction as indicated by arrow (PRIOR ART REF. 201).

As shown in FIG. 12 (PRIOR ART, FIG. 5) the reel seat area (PRIOR ART REF. 164) is positioned into the open chamber region of the rotating retention surface (PRIOR ART REF. 36) of the J-member (PRIOR ART REF. 26). The reel (PRIOR ART REF. 166) is adapted to be interposed between the members (PRIOR ART REF. 35) and (PRIOR ART REF. 37) of the upper retention extension (PRIOR ART REF. 32) as seen in FIG. 12 (PRIOR ART, FIG. 5).

As shown in FIG. 13 (PRIOR ART, FIG. 7), as the fisherman provides the partially vertical force as indicated at (PRIOR ART REF. 210), while the retainer (PRIOR ART REF. 180) is retracted as indicated by the arrow (PRIOR ART REF. 201), the fishing rod is removable by grasping the forward handle region (PRIOR ART REF. 168) and pulling upwardly; however, a downward force, as indicated in FIG. 14 (PRIOR ART, FIG. 6) by vector (PRIOR ART REF. 212) at the forward region (PRIOR ART REF. 211) of the fishing rod, forces the fishing rod (PRIOR ART REF. 162) to remain locked within the fishing rod retention assembly (PRIOR ART REF. 20). The fisherman can place the fishing rod (PRIOR ART REF. 162) into the exposed rod retention conduit (PRIOR ART REF. 152) and thereafter place a downward and laterally inward force to reposition the J-member (PRIOR ART REF. 26) in the direction of the arrow (PRIOR ART REF. 210). Thereafter, the fishing rod retention assembly (PRIOR ART REF. 20) is in a closed position as shown FIG. 11 (PRIOR ART, FIG. 2), whereby the fishing rod (PRIOR ART REF. 160) is locked therein the rod retention conduit (PRIOR ART REF. 152).

Follmar discloses meeting the criteria of positioning a fishing rod in a stored location that is substantially secure from removal upon the load exerted thereon by a fish at the forward end portion of a pole and having easy and convenient access to the fishing rod for removal from the stored location by the fisherman on quick demand when a bite is on the line of the fishing rod line by [symbol] There are numerous advantages to quickly removing a fishing rod such as when fishing from a drift boat where tree limbs and other objects threaten to break the fishing rod while in the stored position; it is desirable for the fisherman to quickly and effectively remove the fishing rod when it is in such a perilous position. Therefore, quick and easy removal of a fishing rod in a timely fashion is desired, so as to make it possible for the rod holder to fight a fish quickly and effectively with minimal struggle and resistance.

One objective is to provide an apparatus for releasably retaining or releasably restricting the undesired movement of an unattended fishing rod before, during, or after use or during use.

A second objective is to provide a lockable hinge clamp for gripping a portion of a handle of a fishing rod.

A third objective is to provide a kit for releasably retaining or releasably restricting the undesired movement of an unattended fishing rod before, during, or after use.

A fourth objective is to provide a method of using a lockable hinge clamp to hold a fishing rod.

Therefore, there is a need for storing, releasably holding, releasably retaining or releasably restricting the undesired movement of a fishing rod before, during, or after use

### SUMMARY OF THE INVENTION

A first aspect of the present invention provides a lockable hinge clamp for securing an unattended fishing rod to the gunnel of a boat. The apparatus is comprised of a fishing rod holder having a releasably coupled spindle, and an extendable fishing rod holder base having a socket. The fishing rod holder is pivotably coupled to the extendable fishing rod holder base by inserting the releasably coupled spindle of the holder into the socket of the extendable fishing rod holder base. The fishing rod holder has a first common joint, which is operably coupled to first and second pivotably coupled straps by means of a first pivot pin. The first pivotably coupled strap has a concave inner surface running between between outer barrels of the first common joint and a distal graspable edge. The second pivotably coupled strap has a concave inner surface running between outer barrels of a second common joint and the outer barrels of the first common joint. The first common joint and the first and second pivotably coupled straps form a three barrel hinge. The fishing rod holder has a releasably coupled spindle. The releasably coupled spindle releasably couples the first pivotably coupled strap to a socket in a beveled edge in the fishing rod holder base. The fishing rod holder also has an pivotable, rotatable mount. The pivotable, rotatable mount comprises a screw, a thumb fastener, two pivot pins press-fitted into a pin coupling, and slidably coupled to the fastener. The pivotable, rotatable mount is operably coupled to the inner barrel of a second common joint. The second common joint is formed by alignment of the outer barrels and inner barrel and insertion of a second pivot pin through the barrels and the inner barrel.

A second aspect of the present invention provides a lockable hinge clamp intended for gripping a portion of a handle of a fishing rod. The lockable hinge clamp intended for gripping a portion of a handle of a fishing rod is comprised of a hinge. The hinge has first and second straps, where each strap has a concave inner surface running between a first common joint and the distal graspable edge. The concave inner surface is pivotably coupled at the first common joint. The concave inner surface of the first and second pivotably coupled straps and the first common joint form a three barrel hinge. The outer barrels and the inner barrel form a second common joint when two pivot pins have been inserted through the barrels after alignment of the barrels. The outer barrels are pivotably coupled to the first pivotably coupled strap, and the middle barrel is pivotably coupled to an pivotable, rotatable mount. The distal graspable edge and the concave inner surface are lockably coupled when the two pivot pins are secured to or released from a lip of the distal graspable edge.

A third aspect of the present invention provides a method of using a lockable hinge clamp to hold a fishing rod. In a first step, a lockable hinge clamp is provided. In a second step a portion of a handle of the rod is clamped between first and second pivotable straps by engaging a pivotable rotatable mount and a distal graspable edge of the lockable hinge clamp, resulting in gripping the handle of the rod. In a third step, the lockable hinge clamp is inserted into an extendable fishing rod holder base. In a fourth step the rod and lockable hinge clamp is removed from the extendable fishing rod holder base without unlocking or removing the lockable hinge clamp. In a fifth step, two pivot pins are extended from about 7.00 mm to about 15 mm from a surface of the second common joint by loosening or tightening the thumb fastener, such that the two pivot pins slidably engage the distal graspable edge of the pivotable strap of the lockable hinge. In a sixth step, the two pivot pins are secured to or released from a lip or valley of the distal graspable edge. Securing the two pivot pins to or releasing it from the lip of the distal graspable edge is done using one hand without the use of a tool. The fishing rod holder releasably retains a handle of a fishing rod, such that the fishing rod is held fast against lateral force in a lateral direction or longitudinal force in a longitudinal direction. The vertical force from a user will release the coupling of the fishing rod holder and the fishing rod holder base, but lateral force in a lateral direction or longitudinal force in a longitudinal direction will not. The fishing rod holder is easily detached from the fishing rod base in a single, instantaneous, smooth motion, allowing the user to pick up or replace the fishing rod with ease.

A fourth aspect of the present invention provides a method of coupling or decoupling an unattended fishing rod to the gunnel of a boat. In a first step, a fishing rod holder and extendable fishing rod holder base are provided. The fishing rod holder releasably holds a handle of a fishing rod, such that the fishing rod is held fast against lateral force in a lateral direction or longitudinal force in a longitudinal direction. The two pivot pins are mechanically coupled to a lip of the distal graspable edge of the first pivotably coupled strap by tightening the thumb fastener, securing the inner barrel of the second common joint and an outer barrels of the second common joint in a manner easily assembled or disassembled with one hand. The fishing rod holder and fishing rod are coupled or decoupled from the extendable fishing rod holder base by having a user apply vertical force to the fishing rod holder. The releasable spindle of the fishing rod holder is coupled or decoupled from the socket of the fishing rod holder base. The vertical force from the user decouples the fishing rod holder from the socket, but lateral force in a lateral direction or longitudinal force in a longitudinal direction will not. The fishing rod holder is easily decoupled from the socket in a single, instantaneous, smooth motion, allowing the user to pick up or replace the fishing rod more easily than would be required to couple or decouple the fishing rod from a fishing rod holder that decouples from the fishing rod.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1A depicts a side elevation view of an open fishing rod holder, in accordance with embodiments of the present invention;

FIG. 1B depicts a cross-sectional view of a locking mechanism taken along line 1B-1B in FIG. 1A, in accordance with embodiments of the present invention;

FIG. 2 depicts a side elevation view of a fishing rod holder base, in accordance with embodiments of the present invention;

FIG. 3 depicts a side elevation view of the fishing rod holder shown in FIG. 1, depicted in FIGS. 1A and 1B, before assembly, in accordance with embodiments of the present invention;

FIG. 4 depicts a side elevation view of the fishing rod holder base shown in FIG. 2, before assembly, in accordance with embodiments of the present invention;

FIGS. 5A and 5B depicts a side view of the fishing rod holder in a closed position, and a cross-sectional view of the slidable coupling along the threaded channel, in accordance with embodiments of the present invention;

FIG. 6 depicts a flow diagram of a method for using a lockable hinge clamp to hold a fishing rod, in accordance with embodiments of the present invention;

FIG. 7 depicts a side view of the fishing rod holder base, shown in FIG. 2, before assembly, in accordance with embodiments of the present invention;

FIG. 8 depicts a side view of the fishing rod holder base, shown in FIG. 2, before assembly, in accordance with embodiments of the present invention;

FIG. 9 depicts a side view of a fishing rod holder Kit 120, including the lockable hinge clamp shown in FIGS. 1A-1B, and a fishing pole 2, in accordance with embodiments of the present invention;

FIG. 10 depicts a side view of an apparatus for operably coupling a fishing rod holder to the gunnel of a boat, in accordance with embodiments of the present invention;

FIGS. 11-14 depict a side view of an apparatus for securing a fishing rod holder to the gunnel of a boat depicted and described in U.S. Pat. No. 7,406,795 B1 to Follmar, hereinafter Follmar.

### DETAILED DESCRIPTION OF THE EMBODIMENTS OF THE INVENTION

### Definitions

Unless otherwise defined, “releasably coupling” is defined as forming or braking or cleaving or severing a mechanical and physical coupling between the removable piece such as the releasably coupled spindle 29 that releasably couples the second pivotably coupled strap 39 and a socket 31 in a beveled edge 32 in the fishing rod holder base 5.

Unless otherwise defined, “distal surface” is defined as the further point along the elongated stem 14 in reference to the underside surface A, J, G, B, and D of the screw head 13, and “proximal surface” is defined as the nearer point along the elongated stem 14 in reference to the underside surface A, J, G, B, and D of the screw head 13.

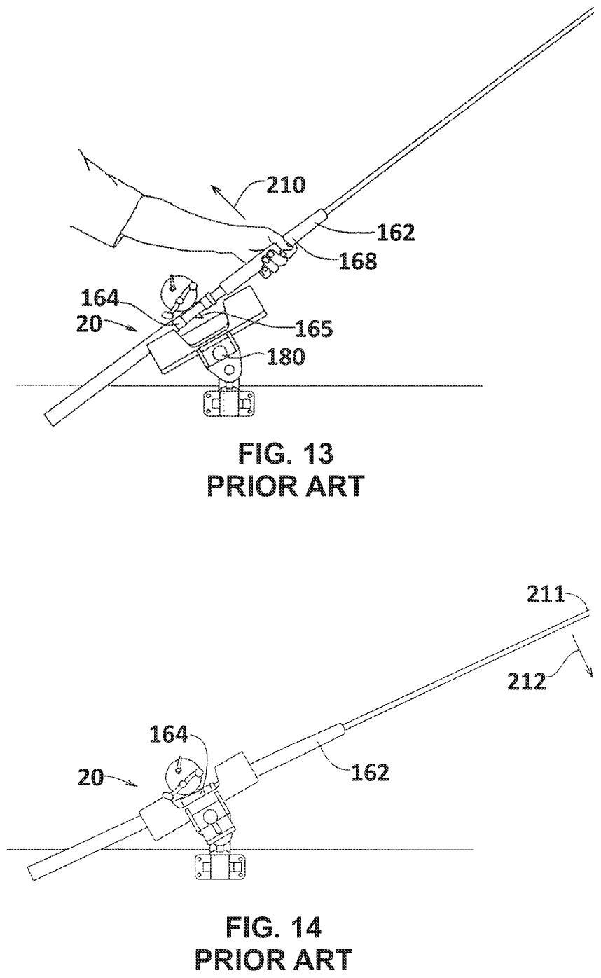

U.S. Pat. No. 7,406,795 B1 to Follmar, hereinafter Follmar discloses an apparatus for securing a fishing rod holder to the gunnel of a boat. In PRIOR ART FIG. 11, Follmar depicts a side view of a fishing rod holder and base (PRIOR ART REF. 20), which is used to secure an unattended fishing rod. The base is secured to a gunnel of a boat. The fishing rod holder comprises a fishing rod handle engaging means (PRIOR ART REF. 26) for clasping or releasing the handle of the fishing rod and a spindle (PRIOR ART REF. 30) for insertion into a socket of the base. The base includes a “locking push button combination” locking mechanism (PRIOR ART REF. 180) for locking the spindle in place once it is inserted into the socket.

In PRIOR ART FIGS. 12, 13 and 14, Follmar depicts a method of insertion of a fishing rod (PRIOR ART REF 162) into the fishing rod handle engaging means (PRIOR ART REF 152) of the fishing rod holder. The fishing rod handle engaging means (PRIOR ART REF 152) is divided into first (PRIOR ART REF 36) and second (PRIOR ART REF 100) operably coupled halves. The fishing rod (PRIOR ART REF 162) is inserted into the first half (PRIOR ART REF 36), and then the fishing rod and the first half (PRIOR ART REF 36) are moved along the operable coupling until the first half (PRIOR ART REF 36) locks into place over the second half (PRIOR ART REF 100).

In PRIOR ART FIGS. 13 and 14, Follmar depicts a method of removing a fishing rod from the fishing rod handle engaging means (PRIOR ART REF 152) of the fishing rod holder. The fishing rod is gripped in hand, and lifted from the fishing rod handle engaging means (PRIOR ART REF 210) in a sharp, upward motion.

Follmar discloses a rod holder mount adapted to hold a fishing rod support mechanism, the rod holder mount having a locking mechanism with an engagement feature positioned on the lateral portion where a stem portion of a fishing rod support mechanism can reposition the locking mechanism to an unlocked state and have it snap back to a locked state at a proper vertical orientation and the fishing rod support mechanism can be removed by repositioning the locking mechanism to an unlocked orientation with respect to the base portion.

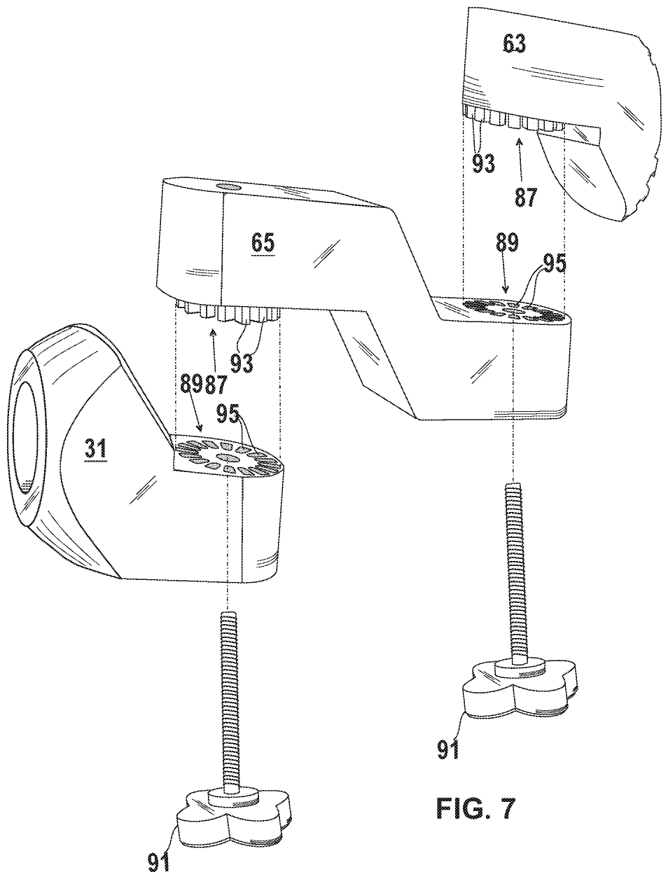

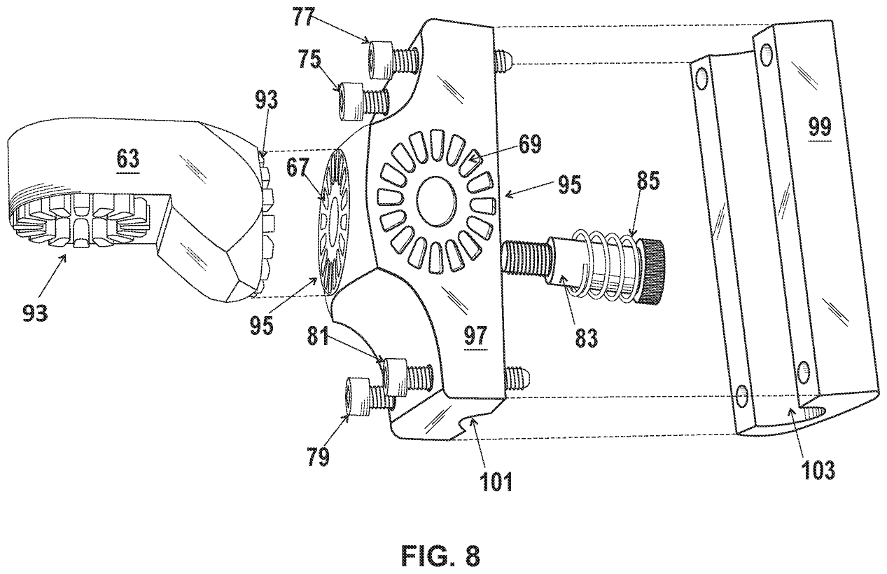

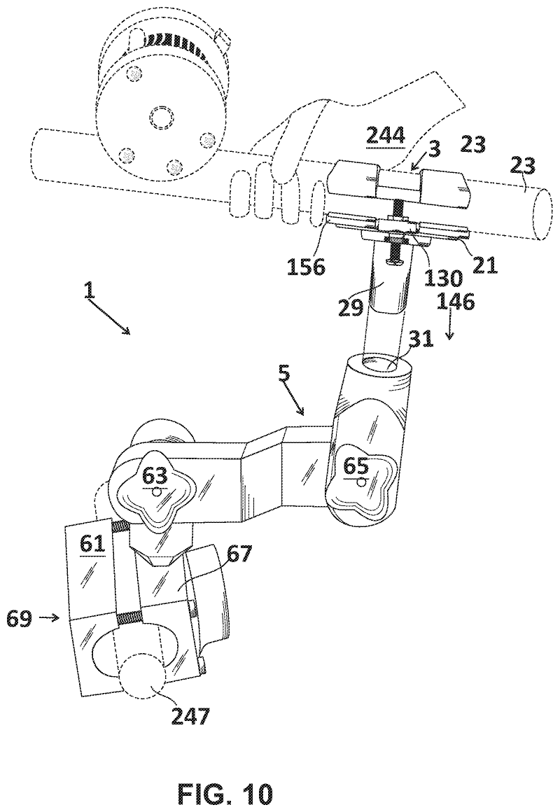

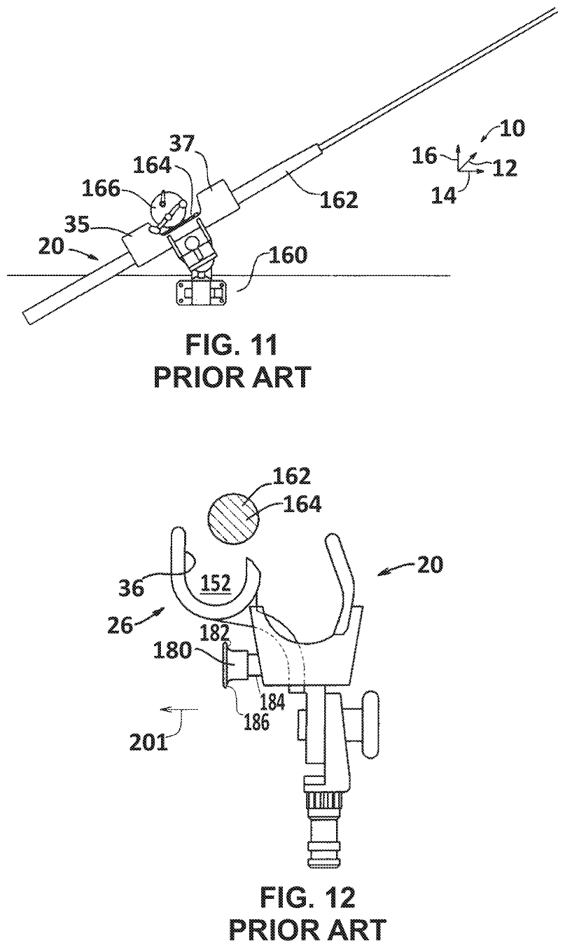

The handle of a fishing rod is placed in a rod holder having a locking mechanism, and that in order to release the fishing rod, one must depress the lock extension, then lift the rod only out of the rod holder. (Please see FIGS. 6 and 7 and column 8 line 54 of Follmar, FIGS. 13 and 14 of the present invention), an awkward and unnecessary motion which takes precious time from dealing with a fish on the line. In all embodiments of the present invention, it is easier to decouple the present invention (FIGS. 9 and 10) than it is to couple or decouple from a fishing rod holder that decouples from the fishing rod (FIGS. 13 and 14). Likewise, anyone could lift all embodiments of the present invention out of the holder with one hand without undue difficulty.

One objective of the present invention is to provide a fishing rod holder that can be easily decoupled from the base with one hand, without the need to remove the fishing rod from the holder. This avoids the need for cumbersome, cost adding features, e.g., push button release locking mechanisms of prior art fishing rod holders.

In contrast to the design and use of the fishing pole holder described in U.S. Pat. No. 7,406,795 B2 to Follmar, the rod holder 3, specifically the spindle 29 of apparatus 1 of the present invention is designed to be easily releasable from the socket 31 of the extendable fishing rod holder base 5 such that a person 244 holding the fishing rod 23 may easily decouple the spindle 29 and socket 31 with one hand because only the weight of the fishing rod 23 and holder 3 must be overcome to effect decoupling of the releasably coupled spindle 29 and socket 31. The inventors have observed a child having enough strength to decouple the fishing rod 23 and holder 3 from the releasably coupled spindle 29 and socket 31.

In addition, unlike the person holding the fishing pole holder described in U.S. Pat. No. 7,406,795 to Follmar, the person 244 holding the fishing rod 23 may orient first and second base mount adjusters 67, 69 of the extendable fishing rod holder base 5 such that the fishing rod holder 3 may be adjusted to an optimal level, wherein the optimal level is based on giving the person 244 an optimal mechanical advantage for easily lifting the fishing rod 23 and holder 3 by decoupling the releasably coupled spindle 29 and socket 31.

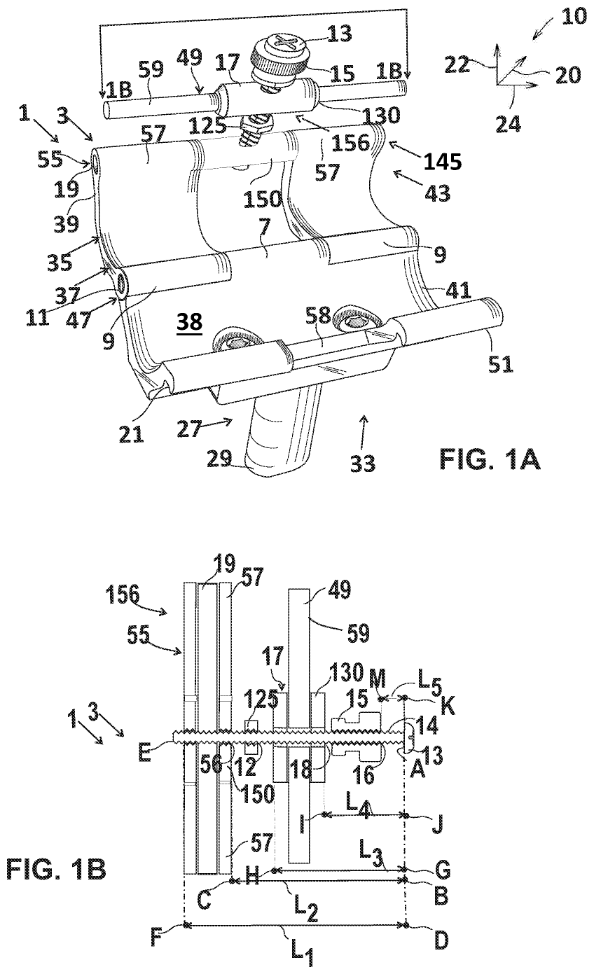

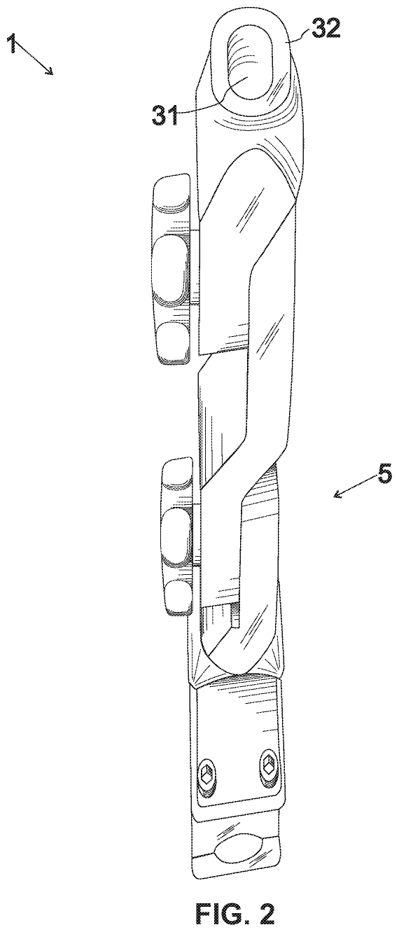

FIG. 1A depicts a side elevation view of an apparatus 1 for securing an unattended fishing rod 2 to the gunnel 247 of a boat, as shown in FIGS. 9-10. An axes system 10 is defined that correlates to the fishing rod holder 3 of the apparatus 1. A longitudinal axis 20 is generally defined by a longitudinal direction 34 along a center axis of the fishing rod handle 23 between first and second pivotable straps 41, 39 shown in FIG. 9, below. A lateral axis 24 as shown in FIG. 1A is defined as a lateral direction 27. A substantially vertical axis 22, as shown in FIG. 1A is defined as a vertical direction 33. The substantially vertical axis 22 is orthogonal to the longitudinal axis 20 and the lateral axis 24. It should be noted that in practice the substantially vertical axis 22 is not perfectly vertical and aligned with the flux field of gravity, but rather, at an angle tilted rearwardly toward the gunnel 247 of a boat or stationary platform (such as a fishing platform) as shown in FIGS. 9-10. It should be noted that the axes system 10 is relative to the fishing rod holder 3 and hence moves therewith.

The apparatus 1 includes a fishing rod holder 3. The fishing rod holder 3 has a releasably coupled spindle 29; and an extendable fishing rod holder base 5. The base 5 includes a socket 31. The fishing rod holder 3 is pivotably coupled to the extendable fishing rod holder base 5 by inserting the releasably coupled spindle 29 of the holder 3 into the socket 31 of the extendable fishing rod holder base 5.

The fishing rod holder 3 includes a first common joint 47, operably coupled to first and second pivotably coupled straps 41, 39 by means of a first pivot pin 11. The first pivotably coupled strap 41 has a concave inner surface 38 running between outer barrels 9 of the first common joint 47 and a distal graspable edge 51. The second pivotably coupled strap 39 has a concave inner surface 43 running between outer barrels 57 of a second common joint 55 and the outer barrels 9 of the first common joint 47.

The first common joint 47 and the first and second pivotably coupled straps 41, 39 form a three barrel hinge 37.

The fishing rod holder 3 includes a releasably coupled spindle 29. The releasably coupled spindle 29 releasably couples the second pivotably coupled strap 39 to a socket 31 in a beveled edge 32 in the fishing rod holder base 5.

The fishing rod holder 3 includes a pivotable, rotatable mount 49. The pivotable, rotatable mount 49 comprises a screw 13, a thumb fastener 15, and two pivot pins 59 press-fitted into a pin coupling 17, and slidably coupled to the fastener 15. The pivotable, rotatable mount 49 is operably coupled to the inner barrel 150 of a second common joint 55 via the stem 14 of the screw 13. The second common joint 55 is formed by alignment of the outer barrels 57 and inner barrel 150 and insertion of the second pivot pin 19 through the barrels 57 and the inner barrel 150.

FIG. 1B depicts a cross-sectional view of a locking mechanism 156 of the fishing rod holder 3 taken along line 1B-1B, depicted in FIG. 1A. The locking mechanism 156 includes a screw 13, a pivotable, rotatable mount 49, a thumb fastener 15, a locking nut 125, and an inner barrel 150 of the second common joint 55. The pivotable, rotatable mount 49 includes two pins 59 operably coupled to a coupling 17 between the two pins 59. The pins 59 may be fixed in a channel 130 of coupling 17 by press-fitting.

The pivotable, rotatable mount 49 is pivotable about a longitudinal axis of the second pivot pin 19 and rotatable about a longitudinal axis of a stem 14 of the screw 13 is operably coupled to the inner barrel 150 of a second common joint 55. The second common joint 55 is formed by alignment of the outer barrels 57 and inner barrel 150 and insertion of two pivot pins 59 through the barrels 57 and the inner barrel 150. When the fishing rod holder is closed around a fishing rod, the pivotable, rotatable mount 49 is secured to a lip 21 in the distal graspable edge 51 of the second pivotably coupled strap 39 by tightening the thumb fastener 15, securing the inner barrel 150 of the second common joint 55 and the outer barrels 57 of the second common joint 55 in a manner easily assembled or disassembled with one hand 244. The locking nut 125 and the pin coupling 17 ensure a firm connection with the lip 21 of the distal graspable edge 51 of the first pivotably coupled strap 41. The two pivot pins 59 do not have any threading, with their movement controlled by the thumb fastener 15, whose threading 16 engages with the threaded stem 14 of the screw 13.

The screw 13 extends 1¾-2¼ inches from A to E. The length L1 extends 1¾+/−0.525 inches from an underside surface D of the head of the screw 15 to a distal surface F of the second common joint 55. The length L2 extends 1½+/−0.45 inches from the proximal surface C of the inner barrel 150 of the second common joint 55 to the underside surface B of the head of the screw 13. The length L3 extends 1¼+/−0.375 inches from the distal surface H of the coupling 17 to the underside G of the head of the screw 13. The length L4 extends ⅞+/−0.3 inches from the proximal surface I of the coupling 17 to the underside J of the head of the screw 13. The length L5 extends ½+/−0.15 inches from the proximal surface M of the thumb fastener 15 to the underside surface K of the screw 13. The pivotable, rotatable mount 49 is extendable from about 7.00 mm to about 15 mm from a surface of the second common joint 55, such that a portion of the handle 23 of the rod 2 is clamped between the first and second pivotable straps 41, 39 by engaging the pivotable, rotatable mount 49 and the distal graspable edge 51, resulting in gripping the handle 23 of the rod 2.

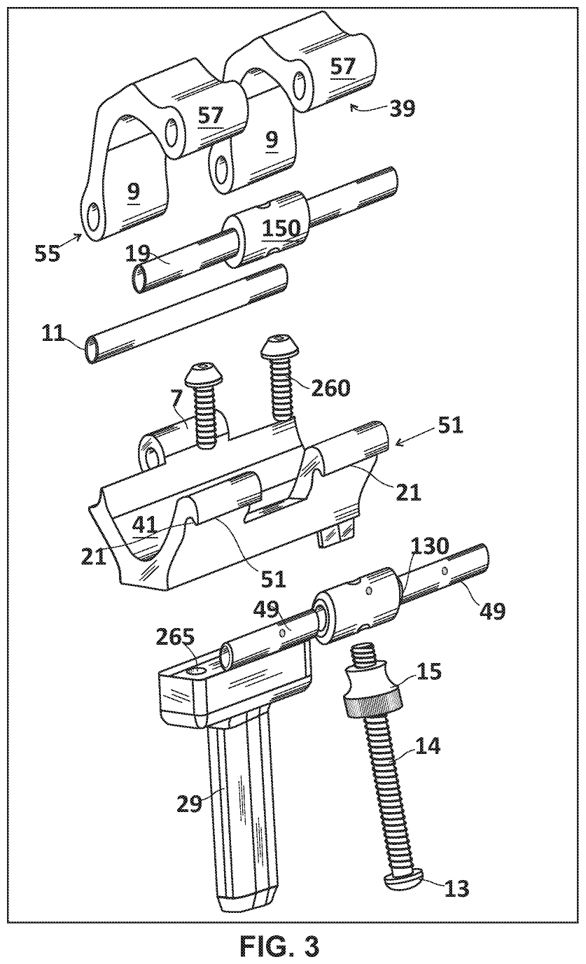

FIG. 2 depicts a side elevation view of the fishing rod holder base 5, including a socket 31 in a beveled edge 32 in the fishing rod holder base 5. The releasably coupled spindle 29 releasably couples the second pivotably coupled strap 39 to a socket 31 in a beveled edge 32 in the fishing rod holder base 5.

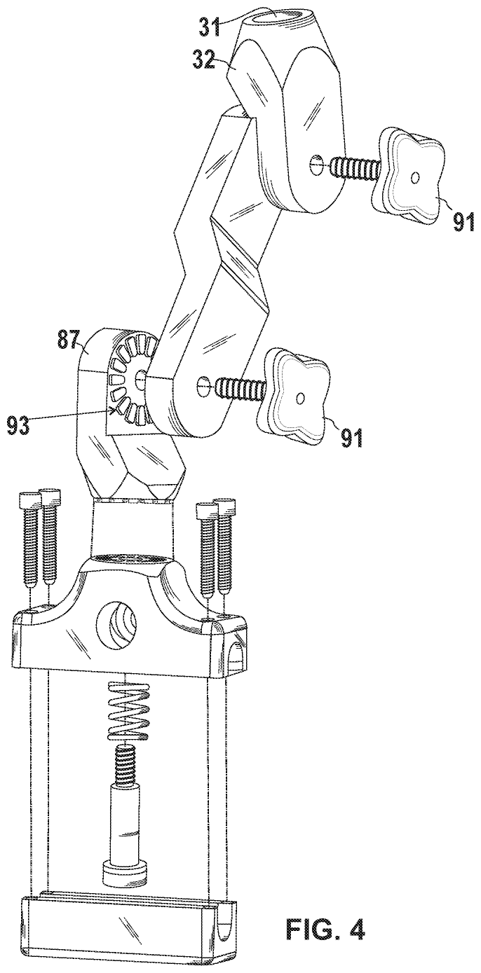

FIG. 3 depicts a side elevation view of the fishing rod holder 3, depicted in FIG. 1A before assembly. The fishing rod holder 3 comprises a lockable hinge clamp 35 for gripping a portion of a handle of a fishing rod comprises a hinge 37. The locking mechanism 156 grips a portion of a handle 23 of a fishing rod 2. The hinge has first and second straps 41, 39, where each strap has a concave inner surface 38, 43 running between a first common joint 47 and the distal graspable edge 51. The concave inner surfaces 38, 43 of the first and second pivotably coupled straps 41, 39 and the first common joint form a three barrel hinge. The outer barrels 57 and the inner barrel 150 form a second common joint 55 when two pivot pins 59 have been inserted through the barrels 7, 9 after alignment of the barrels. The outer barrels 57 are pivotably coupled to the second pivotably coupled strap 39, and the middle barrel 105 is pivotably coupled to a pivotable, rotatable mount 49. The distal graspable edge 51 and the concave inner surface 43 are lockably coupled when the two pivot pins 59 are secured to or released from a lip 21 of the distal graspable edge 51.

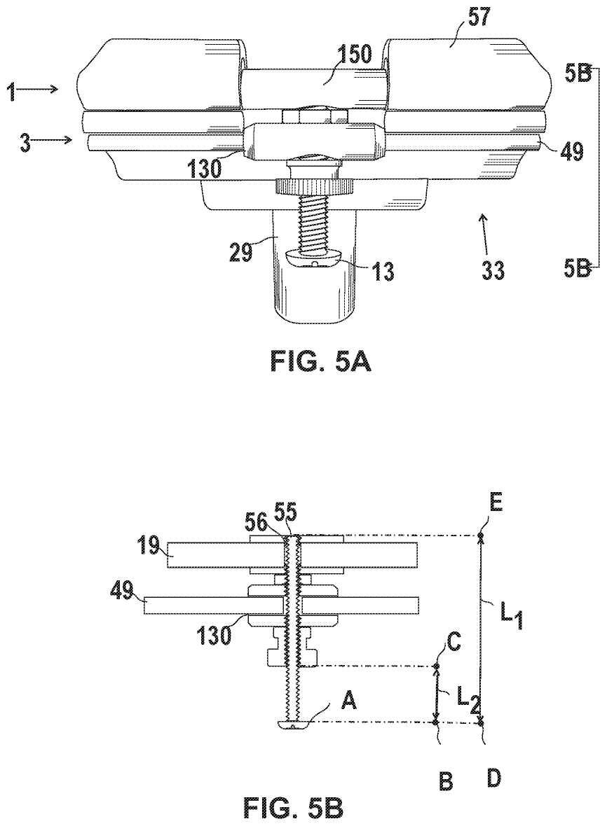

FIG. 4 depicts a side elevation view of the fishing rod holder base, disassembled into relevant parts. A base mounting block 61 is comprised of a first mounting block 97 and a second mounting block 99. The first and second mounting blocks 97, 99 have first and second rail halves 101, 103. The first and second mounting blocks 97, 99 allow the base to be mounted on a rail by operably coupling the rail between the first and second mounting blocks 97, 99 by means of first, second, third and fourth locking pins 75, 77, 79, 81.

The first and second base angle adjusters 63, 65 are comprised of a male end 87, a female end 89, and a knob 91. The male end 87 has a series of male pins 93 which are arrayed in a circle at a set of regular intervals. The female end 89 has a series of female slots 95 which are arrayed at a matching set of regular intervals. The male and female ends 87, 89 are able to be operably coupled at a series of angles, and the knob 91 allows the connection of the male and female ends to be secured in place or readjusted at will by a user. In an embodiment, the pins 93 of the male end 87 of the angle adjuster 63, 65 are arrayed at 22.5 degrees apart. A preferred embodiment of the present invention allows the first and second base mount adjusters 180 degrees of freedom, divided by adjusting the male and female ends in 22.5 degree implements.

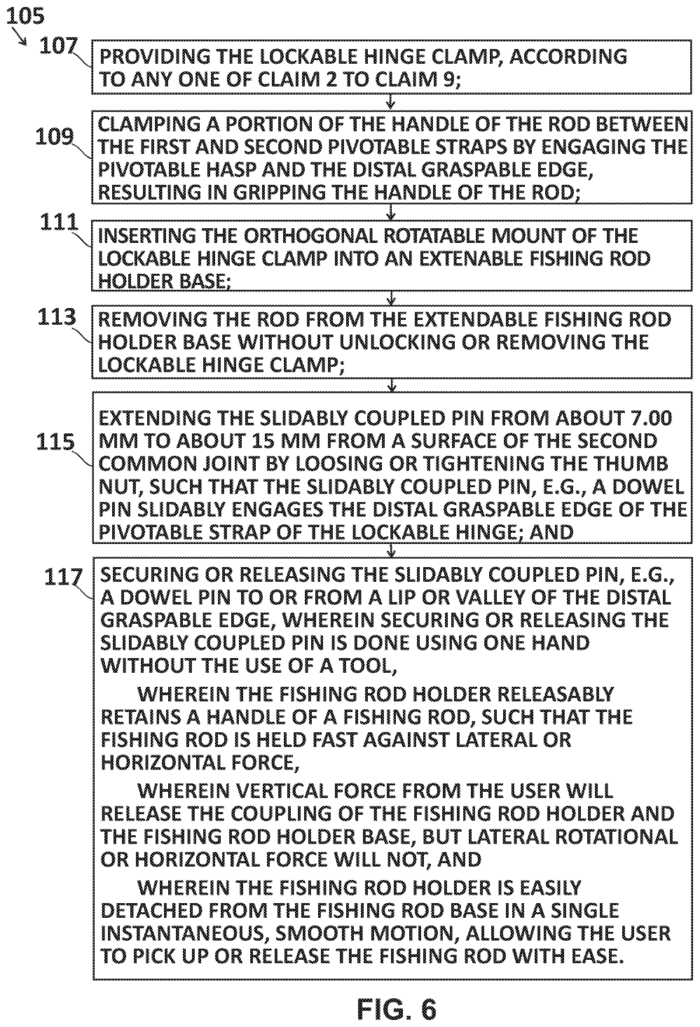

FIG. 5A depicts a side view of the fishing rod holder while closed, and FIG. 5B depicts a cross-sectional view of the slidable coupling along the threaded channel, taken along line 5B-5B in FIG. 5A. There is a pivotable, rotatable mount 49 parallel to the second common joint 155. In one embodiment, the distal graspable edge 51 has a hollow hemispherical shape and lip therein. In one embodiment, the pivotable, rotatable mount 49 is T shaped. In one embodiment, the pivotable, rotatable mount 49 is part of a locking mechanism 156 comprised of a screw 13, a thumb fastener 15, a pin coupling 17 and a pivotable, rotatable mount 49 slidably coupled to the screw 15.

FIG. 5B depicts a cross-sectional view of the preferred embodiment of the closed or locked locking mechanism, taken along line 5B-5B in FIG. 5A. The length L1 extends 1¾+/−0.525 inches from the distal surface F of the second common joint 55 to the underside surface D of the head of the screw 15. In one embodiment, the length L2 extends ½+/−0.15 inches from a proximal surface C of the thumb fastener 15 to the underside surface B of the screw 13.

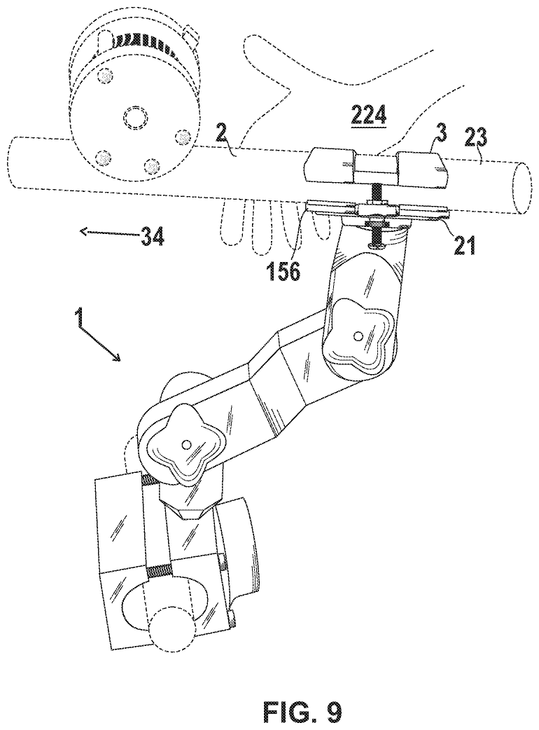

FIG. 8 depicts a side elevation view of the extendable fishing rod holder base 5, disassembled into relevant parts. The extendable fishing rod holder base 5 is comprised of a first base mount adjuster 67, a second base mount adjuster 69, and the socket 31 of the fishing rod holder base 5. The mounting block 61 is comprised of a first base mount adjuster 63 and a second base mount adjuster 65. The first base angle adjuster 63 is operably coupled to the first or second base mount adjuster 67, 69 of the mounting block 61 by means of a shoulder bolt 83 and spring 85. Lastly, the second angle base adjuster 65 is operably coupled to the first base mount adjuster 63 and the socket 31 of the extendable fishing rod holder base 5.

The first and second base mount adjusters 67, 69 allows the base 5 to be mounted below the base 5 or at a 90 degree angle from the base 5 by means of first, second, third and fourth locking pins 75, 77, 79, 81. In an embodiment, the first and second base angle adjusters 63, 65 allow the first base mount adjuster 63 to be set at a variety of angles and heights from the base mount.

A method of coupling or decoupling an unattended fishing rod 2 to the gunnel 247 of a boat using the apparatus 1, as depicted in FIGS. 1A-1B and 5A-5B. The first step of the method provides the fishing rod holder 3 and extendable fishing rod holder base 5, where the fishing rod holder 3 releasably holds a handle of a fishing rod 2, such that the fishing rod is held fast against lateral force in a lateral direction 27 or longitudinal force in a longitudinal direction 34. Next, the two pivot pins 59 are mechanically coupled to a lip 21 of the distal graspable edge 51 of the first pivotably coupled strap 41 by tightening the thumb fastener 15, securing the inner barrel 150 of the second common joint 55 and the outer barrels 57 of the second common joint 55 in a manner easily assembled or disassembled with one hand 244. Next, the fishing rod holder 3 and fishing rod 2 are coupled or decoupled from the extendable fishing rod holder base 5 by having a user apply vertical force in the vertical direction 33 to the fishing rod holder 3. Last, the releasable spindle 29 of the fishing rod holder 3 is coupled or decoupled from the socket 31 of the fishing rod holder base 5. Vertical force in the vertical direction 33 from the user decouples the fishing rod holder 3 from the socket 31, but lateral force in the lateral direction 27 or longitudinal force in the longitudinal direction 34 will not. The fishing rod holder 3 is easily decoupled from the socket 31 in a single, instantaneous, smooth motion, allowing the user to pick up or replace the fishing rod 2 more easily than would be required to couple or decouple the fishing rod from a fishing rod holder that decouples from the fishing rod.

In one embodiment, the pivotable, rotatable mount 49 is operably coupled to the inner barrel 150 of the second common joint 55 by means of a second three barrel hinge 145.

In one embodiment, the socket 31 of the fishing rod holder base 5 has a beveled edge 32, such that the releasable spindle 29 may be easily gripped by one hand 244 so that it may be rotated about the socket 31 of the fishing rod holder 3.

FIG. 9 depicts a side view of a fishing rod holder Kit 120, including the apparatus 1. Apparatus 1 is a kit comprised of a fishing rod 2 and an extendable fishing rod holder base 5, and a hinge. The locking hinge clamp 35 has a releasable spindle 29, which is releasably operably coupled to a socket 31 of the fishing rod holder base 5, and the rod 2 is removable from the extendable fishing rod holder base 5 without unlocking or removing the lockable hinge clamp 35.

In an embodiment, the fishing rod holder 3 releasably retains a handle of a fishing rod 2, such that the fishing rod is held fast against lateral force in a lateral direction 27 or longitudinal force in a longitudinal direction 34.

In an embodiment, the fishing rod holder 3 is easily detached from the fishing rod base in a single, instantaneous, smooth motion, allowing the user to pick up or replace the fishing rod with ease.

FIG. 6 depicts a flow diagram of a method 105 for using a lockable hinge clamp 35 to hold a fishing rod 2. In a step 107 of the method 105 provides a lockable hinge clamp 35. In a step 109 of the method 105, a portion of the handle 23 of the rod 2 is clamped between the first and second pivotable straps 41, 39 by engaging the pivotable, rotatable mount 49 and the distal graspable edge 51, resulting in gripping the handle 23 of the rod 2. In a 111 of the method 105, the pivotable rotatable mount 49 of the lockable hinge clamp 35 is inserted into an extendable fishing rod holder base 5. In a step 113 of the method 105, the rod 2 is removed from the extendable fishing rod holder base 5 without unlocking or removing the lockable hinge clamp 35.

In one embodiment, the method 105 further comprises a step 115, in which the two pivot pins 59 are extended from about 7.00 mm to about 15 mm from a surface of the second common joint 55 by loosening or tightening the thumb fastener 15, such that the two pivot pins 59 slidably engage the distal graspable edge 51 of the pivotable strap 41 of the lockable hinge 35.

In one embodiment, the method 105 further comprises a sixth step 117, providing securing or releasing the two pivot pins 59 to or from a lip 21 of the distal graspable edge 51 of the first pivotable strap 41 is done using one hand 244 without the use of a tool. The fishing rod holder 3 releasably retains a handle 23 of a fishing rod 2, such that the fishing rod 2 is held fast against lateral force in a lateral direction 27 or longitudinal force in a longitudinal direction 34. Vertical force in a vertical direction 33 from the user will release the spindle 29 of the fishing rod holder 3 from the socket 31 the fishing rod holder base 5, but lateral force in a lateral direction 27 or longitudinal force in a longitudinal direction 34 will not. The fishing rod holder 3 is easily detached from the fishing rod base 5 in a single, instantaneous, smooth motion, allowing the user to pick up or replace the fishing rod with ease.

FIG. 7 depicts a side view of the fishing rod holder base, disassembled into relevant parts, in accordance with embodiments of the present invention.

In an embodiment, the socket 31 of the extendable fishing rod holder 3 includes a plastic socket insert 1100 insertable in the direction of an arrow 1130 into the socket 31. A groove 1140 has been circumscribed in a face of a beveled edge 32 in the fishing rod holder base 5, into which an overlapping lip 1160 extending from the rim 1180 of the plastic insert 1200 inserts. Insertion of the lip 1160 into the groove 1140 operably couples the plastic insert 1100 to the beveled edge 32 in the fishing rod holder base 5. The socket 31 of the extendable fishing rod holder and the releasably coupled spindle 29 have aligned channels 1200 for a pin 1300 to be inserted for stabilization during travel.

FIG. 9 depicts a side view of an apparatus 1 for operably coupling a fishing rod holder 3 to the gunnel 247 of a boat, before a releasably coupled spindle 29 has been inserted into socket 31. The apparatus 1 comprises the fishing rod holder 3, which has a locking mechanism 156, including a releasably coupled rotatable and pivotable, rotatable mount 49, and a releasably coupled spindle 29, an extendable fishing rod holder base 5, which has a socket 31, and a base mounting block 61, the base mounting block 61 for operably coupling the apparatus 1 to a boat, e.g. the gunnel 247 of the boat.

FIG. 10 depicts a side view of the apparatus 1, shown in FIG. 9 and described in associated text after a user has inserted the releasably coupled spindle 29 into the socket 31 by exerting a pushing motion in the direction of an arrow 146 using his hand 244, as depicted in FIG. 9, and described in associated text. FIG. 10 also shows the fishing rod holder and fishing rod base, immediately after separation. The fishing rod holder and the fishing rod holder base can be easily coupled or decoupled with one hand 244, in all embodiments of the present invention. The socket 31 of the extendable fishing rod holder and the releasably coupled spindle 29 have aligned channels 1200 after the user has inserted the releasably coupled spindle 29 into the socket 31 by exerting a pushing motion in the direction of an arrow 146 using his hand 244. A pin 1300 may be inserted into the aligned channels 1200 for stabilization during travel.

The rod holder 3, specifically the spindle 29 of apparatus 1 of the present invention is designed to be easily releasable from the socket 31 of the extendable fishing rod holder base 5 such that a person 244 holding the fishing rod 23 may easily decouple the spindle 29 and socket 31 with one hand 244 because only the weight of the fishing rod 23 and holder 3 must be overcome to effect decoupling of the releasably coupled spindle 29 and socket 31. The inventors have observed a child having enough strength to decouple the fishing rod 23 and holder 3 from the releasably coupled spindle 29 and socket 31.

For example, referring to FIG. 7, a plastic socket insert 1100 may be inserted between spindle 29 and the socket 31 thus avoiding metal on metal contact between the spindle 29 and the socket 31 when the rod holder 3 is either rotated in the socket 31 or removed from said socket 31.

While exemplary embodiments have been specifically disclosed, it should be understood that the practice of this invention is not limited to those embodiments. Modifications and variations falling within the spirit of the invention will occur to those skilled in the art. Therefore, it is not intended that the scope of the invention be determined by the disclosed exemplary embodiments, but rather should be determined by the breadth of the appended claims.

1. A lockable hinge clamp for securing an unattended fishing rod (2) to the gunnel of a boat, comprising:
a fishing rod holder (3) having a releasably coupled spindle (29); and an extendable fishing rod holder base (5) having a socket (31),
wherein the fishing rod holder (3) is pivotably coupled to the extendable fishing rod holder base (5) by inserting the releasably coupled spindle (29) of the holder (3) into the socket (31) of the extendable fishing rod holder base (5),
the fishing rod holder (3) comprising:
a first common joint (47), operably coupled to first and second pivotably coupled straps (41, 39) by means of a first pivot pin (11),
wherein the first pivotably coupled strap (39) has a concave inner surface (38) running between outer barrels (9) of the first common joint (47) and a distal graspable edge (51),
wherein the second pivotably coupled strap (39) has a concave inner surface (43) running between outer barrels (9) of the first common joint (47) and outer barrels (57) of a second common joint (55),
wherein the first common joint (47) and the first and second pivotably coupled straps (41, 39) form a three barrel hinge (37);
a releasably coupled spindle (29)
wherein the releasably coupled spindle (29) releasably couples the first pivotably coupled strap (41) to a socket (31) in a beveled edge (32) in the fishing rod holder base (5); and
a pivotable, rotatable mount (49),
wherein the pivotable, rotatable mount (49) comprises a screw (13), a thumb fastener (15), two pins (59) connected by a press-fitted coupling (17) slidably coupled to the fastener (15),
wherein the pivotable, rotatable mount (49) is operably coupled to the inner barrel (150) of a second common joint (55),
wherein the second common joint (55) is formed by alignment of the outer barrels (57) and inner barrel (150) and insertion of two pivot pins (59) through the outer barrels (57) and the inner barrel (150).

2. The lockable hinge clamp of claim 1, further comprising a plastic socket insert (1100) operably coupled to the socket.

3. The lockable hinge clamp of claim 1, further comprising aligned holes (1200) through the socket (31) of the extendable fishing rod holder base (5) and the releasably coupled spindle (29) for a pin (1300) to be inserted for stabilization during travel.

4. The lockable hinge clamp of claim 1, wherein the pivotable, rotatable mount (49) is operably coupled to the inner barrel of the second common joint by means of a second three barrel hinge.

5. The lockable hinge clamp of claim 1, wherein the end of the fishing rod holder base has a beveled edge (32), such that the releasable spindle (29) may be easily gripped by one hand (244) so that it may be rotated about the socket (31) of the fishing rod holder (3).

6. The lockable hinge clamp of claim 1, wherein the distal graspable edge has a hollow hemispherical shape and lip therein.

7. (Currently Amended The lockable hinge clamp of claim 1, wherein the pivotable, rotatable mount is T shape.

8. The lockable hinge clamp of claim 1, wherein the pivotable, rotatable mount comprises a screw (13), two pins (59) connected by a press-fitted coupling (17), and -slidably coupled to the screw (13).

9. A kit for holding a fishing rod, comprising:
a fishing rod; and
the lockable hinge clamp of claim 1,
wherein the rod is removable from the extendable fishing rod holder base without unlocking or removing the fishing rod holder.

10. The kit of claim 9, wherein the fishing rod holder releasably retains a handle of a fishing rod, such that the fishing rod is held fast against lateral force (27) in a lateral direction or longitudinal force (34) in a longitudinal direction.

11. The kit of claim 9, wherein vertical force (33) from a user will release the coupling of the fishing rod holder and the fishing rod holder base, but lateral force in a lateral direction or longitudinal force in a longitudinal direction will not.

12. The kit of claim 9, wherein the fishing rod holder is easily detached from the fishing rod base in a single, instantaneous, smooth motion, allowing a user to pick up or replace the fishing rod with ease.

13. The kit of claim 9, wherein the fishing rod holder base is comprised of a mounting block, a first base mount adjuster, a second base mount adjuster, and the end of the fishing rod holder base,
wherein the mounting block is comprised of a first base mount adjuster and a second base mount adjuster
wherein a first base angle adjuster is operably coupled to the first or second base mount adjuster of the mounting block by means of a shoulder bolt and spring, and
wherein a second angle base adjuster is operably coupled to the first base mount adjuster and the end of the fishing rod holder base.

14. The kit of claim 13, wherein the first and second base mount adjusters allows the base to be mounted below the base or at a 90 degree angle from the base by means of first, second, third and fourth locking pins.

15. The kit of claim 14, wherein the first and second base angle adjusters allow the first base mount adjuster to be set at a variety of angles and heights from the base mount.

16. The kit of claim 15, wherein the first and second base angle adjusters are comprised of a male end, a female end, and a knob,
wherein the male end has a series of male pins are arrayed in a circle at a set of regular intervals,
wherein the female end has a series of female slots are arrayed at a matching set of regular intervals,
wherein the male and female ends are operably couplable at a series of angles, and
wherein the knob allows the connection of the male and female ends to be secured or readjusted at will by a user.

17. The kit of claim 13, wherein the pins of the male end of the angle adjuster are arrayed at 22.5 degrees apart.

18. The kit of claim 13, wherein the base mounting block comprises a first mounting block and a second mounting block,
wherein the first and second mounting blocks have first and second rail halves, and
wherein the first and second mounting blocks allow the base to be mounted on a rail by operably coupling the rail between the first and second mounting blocks by means of first, second, third and fourth locking pins.

19. A method (105) of using the lockable hinge clamp of claim 1 to hold a fishing rod, comprising:
providing the lockable hinge claim of claim 1;
clamping a portion of a handle of the rod between first and second pivotable straps by engaging a pivotable mount (49) and a distal graspable edge of the lockable hinge clamp (35), resulting in gripping the handle of the rod;
inserting the lockable hinge clamp into an extendable fishing rod holder base; and
removing the rod and lockable hinge clamp from the extendable fishing rod holder base without unlocking or removing the lockable hinge clamp (3).

20. The method of using the lockable hinge clamp of claim 1 to hold a fishing rod, comprising:
extending two pivot pins (59) from about 7.00 mm to about 15 mm from a surface of the second common joint by loosening or tightening the thumb nut, such that each pivot pin engages the distal graspable edge of the pivotable strap of the lockable hinge.

21. The method of using the lockable hinge clamp to hold a fishing rod of claim 20, comprising:
securing each pivot pin (59) to a lip or valley of the distal graspable edge,
wherein securing or releasing each pivot pin (59) is done using one hand (244) without the use of a tool,
wherein the lockable hinge clamp releasably retains a handle of a fishing rod, such that the fishing rod is held fast against lateral force in a lateral direction or longitudinal force in a longitudinal direction,
wherein vertical force from a user will release the coupling of the lockable hinge clamp and the fishing rod holder base, but lateral force in a lateral direction or longitudinal force in a longitudinal direction will not, and
wherein the lockable hinge clamp is easily detached from the fishing rod base in a single, instantaneous, smooth motion, allowing the user to pick up or replace the fishing rod with ease.
